(19) United States
(12) Patent Application Publication
(10) Pub. No.: US 2013/0141585 A1
(43) Pub. Date: Jun. 6, 2013

(54) CHECKOUT SYSTEM AND METHOD FOR OPERATING CHECKOUT SYSTEM

(71) Applicants: Hidehiro NAITO, Shizuoka (JP); Hitoshi Ilzaka, Shizuoka (JP); Atsushi Okamura, Miyagi (JP); Hidehiko Miyakoshi, Miyagi (JP); Masahide Ogawa, Shizuoka (JP); Hiroshi Sugasawa, Miyagi (JP)

(72) Inventors: Hidehiro NAITO, Shizuoka (JP); Hitoshi Ilzaka, Shizuoka (JP); Atsushi Okamura, Miyagi (JP); Hidehiko Miyakoshi, Miyagi (JP); Masahide Ogawa, Shizuoka (JP); Hiroshi Sugasawa, Miyagi (JP)

(21) Appl. No.: 13/690,766

(22) Filed: Nov. 30, 2012

(30) Foreign Application Priority Data
Dec. 2, 2011 (JP) 2011-265155

(51) Int. Cl. G06Q 20/20; H04N 7/18

(52) U.S. Cl. CPC G06Q 20/208; H04N 7/18
USPC 348/150

(57) ABSTRACT

A checkout system of an embodiment of the present disclosure has an image pickup unit, a computing unit, a display control unit, a receiving unit, and a registering unit. The image pickup unit takes pictures of a commodity at a prescribed frame rate. The computing unit computes a similarity coefficient between standard images of each commodity and the acquired image to identify possible matches to the acquired image. The display control unit displays information corresponding to the candidate matches with a high similarity coefficient on a display unit. The similarity coefficient is determined on the basis of a comparison between images of the object acquired by the image pickup unit and a standard image. The receiving unit receives selection of the commodity information on the display unit. The registering unit executes a registration treatment according to the selected information.

### CROSS-REFERENCE TO RELATED APPLICATION

This application is based upon and claims the benefit of priority from Japanese Patent Application No. 2011-265155, filed Dec. 2, 2011; the entire contents of which are incorporated herein by reference.

### FIELD

Embodiments described herein relate generally to a checkout system and a method for operating the checkout system.

### BACKGROUND

In the prior art, there is a technology related to generic object recognition, whereby characteristic features of an object are extracted from data of an image/picture taken of the object, and the extracted data are compared with previously gathered comparison data (characteristic features), so that the object can be generally recognized (detected) and/or characterized by type. A system adopting the generic object recognition technology to characterize types of food and beverages has been proposed. In a conventional object recognition system, images of possible candidates for the actual object are displayed on a display screen after the object is recognized and characterized, and the final candidate must be chosen by an operator (e.g., a salesperson) from the display screen.

However, with this generic object recognition technology, it may be necessary for the operator to recognize a plurality of different commodities/articles as possible candidates for the object. In this case, although an operator can select from the candidate commodities, the scheme may hamper selection of the commodity if the candidates are listed and displayed randomly. Consequently, there is a demand for the development of a technology that can efficiently select the commodity from the candidates.

### DESCRIPTION OF THE DRAWINGS

FIG. 1 is an oblique view illustrating an example of a checkout system.

FIG. 2 is a block diagram illustrating a POS terminal and a commodity reading device.

FIG. 3 is a schematic diagram illustrating an example of data of a PLU file.

FIG. 4 is a block diagram illustrating the functional constitution of the POS terminal and the commodity reading device.

FIG. 5 is a flow chart illustrating an example of an operation of the checkout system according to the present embodiment.

FIG. 6 is a schematic diagram illustrating an example of a reading region in a reading window.

FIG. 7 is a flow chart illustrating an example of an operation of a commodity candidate presentation treatment.

FIG. 8 is a diagram illustrating an example of a commodity image table that stores commodity images corresponding to a frame image.

FIG. 9 is a diagram illustrating an example of a commodity image weight table that stores the sum point number for each commodity image in each image group.

FIG. 10 is a diagram illustrating an example of selection results for the commodity image with a high similarity coefficient.

FIG. 11 is a diagram illustrating an example of a display position table that stores a result of a decision regarding a display position of the selected commodity image.

FIG. 12 is a diagram illustrating an example of results of a decision of a display size of the selected commodity image.

FIG. 13 is a diagram illustrating a commodity candidate presentation treatment.

FIG. 14 is a diagram illustrating an example of displaying a commodity name as the commodity information in the commodity candidate presentation treatment.

### DETAILED DESCRIPTION

The shopping system and program according to an embodiment of the present disclosure will be explained using a checkout system as an example, with reference to the figures. The shopping system refers to the checkout system (POS system) having a point of sales (POS) terminal for carrying out registration and debt settlement of commodities related to each transaction, etc. In this embodiment, the checkout system may be adopted in, for example, supermarkets and other shops.

The shopping system has an image pickup unit, a computing unit, a display control unit, a receiving unit, and a registering unit. The image pickup unit takes pictures at a prescribed frame rate to acquire images of product items (picked up images).

The computing unit computes a similarity coefficient between a standard image of each candidate commodity and an image of an object contained in the picked up images. The standard image for each candidate commodity is obtained beforehand.

The display control unit displays commodity information on the display unit for a candidate commodity corresponding to the standard image having a high similarity to the product item image the basis of the similarity coefficient between the image of the object, which is contained in the last picked up image and the preceding picked up image, and the standard image.

The receiving unit receives a selection of the commodity information displayed on the display unit.

The registering unit executes registration treatment corresponding to the received commodity information.

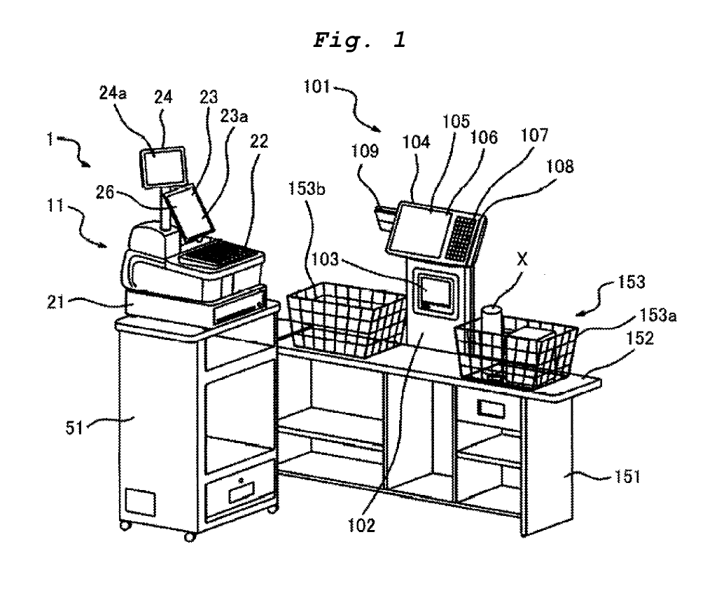

FIG. 1 is an oblique view illustrating an example of the checkout system. As shown in FIG. 1, here, a checkout system 1 has a POS terminal 11 that carries out registration and debt settlement for the commodity in each transaction. The POS terminal 11 is positioned on the upper surface of a drawer 21 on a checkout table 51. The drawer 21 opens under the control of the POS terminal 11. On the upper surface of the POS terminal 11, a keyboard 22 for key-in operations, is arranged for an operator (salesperson). A display device 23 for displaying information to the operator is arranged behind the keyboard 22 as viewed by the operator who manipulates it. The display device 23 displays the information on its screen 23a. A touch panel 26 is laminated on the screen 23a. A customer display device 24 is installed behind the display device 23 in such a manner as to be freely rotatable. The customer display device 24 displays the information on its screen 24a. The customer display device 24 has its screen facing forward as shown in FIG. 1. However, the screen 24a may also be arranged to face backward by rotating it so that it displays the information for the customer to see.

A counter table 151 in a lateral table shape is arranged to form an L-shape with the checkout table 51 where the POS terminal 11 is situated. On the upper surface of the counter table 151, a load receiving surface 152 is formed. On the load receiving surface 152, a shopping basket 153 containing various items (commodities X) may be placed. The shopping basket 153 may be formed so as to be divided into a first shopping basket 153a and a second shopping basket 153b with a commodity reading device 101 between them. The shape of either shopping basket 153a and 153b are not limited to a simple basket shape; they may also be in a tray shape, a box shape, a bag shape, or the like.

On the load receiving surface 152 of the counter table 151, the POS terminal 11 and the commodity reading device 101 connected for transmission/reception are arranged. Here, the commodity reading device 101 has a thin rectangular-shaped housing 102. A reading window 103 is arranged on the front side of the housing 102. On the top of the housing 102, a display/operating part 104 is attached. On the display/operating part 104, a display device 106 having a touch panel 105 laminated on its surface is arranged. A keyboard 107 is arranged adjacent to the right hand side of the display device 106. Adjacent to the right hand side of the keyboard 107 is a card slot 108 for a card reader not shown in the figure. A display device 109 for a customer providing information to the customer is arranged on the left side behind the back surface of the display/operating part 104 from the viewpoint of the operator.

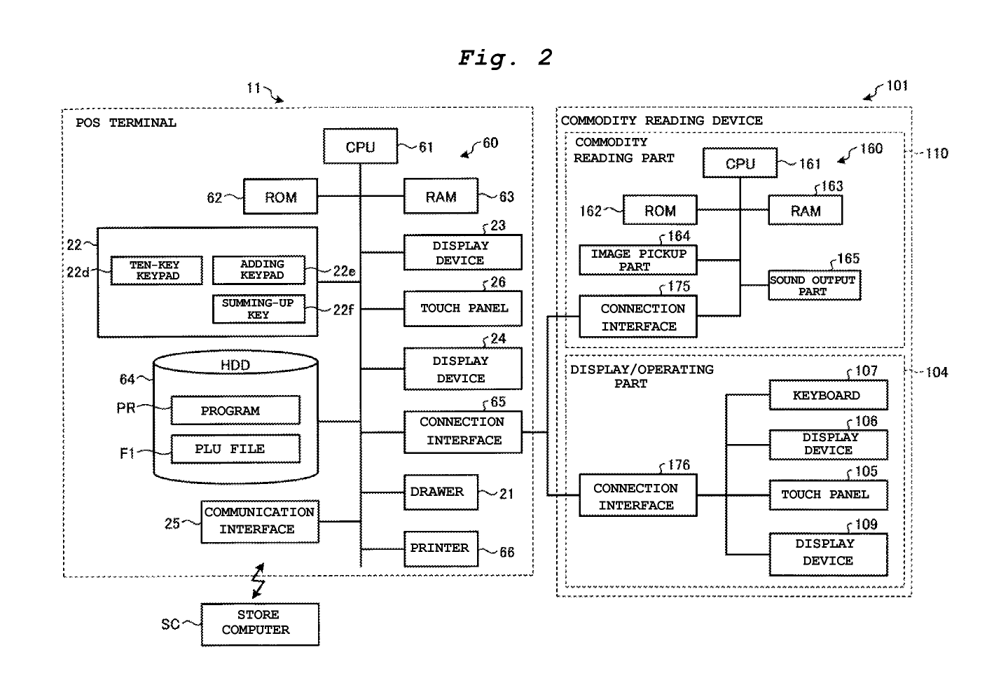

The commodity reading device 101 has a commodity reading part 110 (see FIG. 2). The commodity reading part 110 has an image pickup part 164 (see FIG. 2) arranged behind the reading window 103.

In the first shopping basket 153a held by the customer, the commodities X related to a transaction are contained. The commodities X in the first shopping basket 153a are then transferred to the second shopping basket 153b by the operator who operates the commodity reading device 101. In the transfer process, each commodity X is made to face the reading window 103 of the commodity reading device 101. In this case, an image of the commodity X is taken by the image pickup part 164 arranged in the reading window 103 (see FIG. 2).

In the commodity reading device 101, the image that indicates whether the commodity X contained in the image taken by the image pickup part 164 (see FIG. 2) corresponds to the commodity registered in a PLU (price look-up) file F1, to be explained later, is displayed on the display/operating part 104, and a commodity ID of the indicated commodity is sent to the POS terminal 11. At the POS terminal 11, on the basis of a commodity ID notification sent from the commodity reading device 101, a commodity class, commodity name, unit price, and other information related to sales registration of the commodity corresponding to the commodity ID, are recorded to register the sale in a master sales file (not shown in the figure).

FIG. 2 is a block diagram illustrating a POS terminal and commodity reading device. Here, the POS terminal 11 has a microcomputer 60 as a information processing part for executing information processing. The microcomputer 60 includes a central processing unit (CPU) 61 that carries out various types of arithmetic and logic operations to control the various parts, a read only memory (ROM) 62, and a random access memory (RAM) 63, which are connected with each other by a bus.

Connected to the CPU 61 of the POS terminal 11 are the drawer 21, keyboard 22, display device 23, touch panel 26, and the customer's display device 24, via various types of input/output circuits (not all shown in the figure). These are controlled by the CPU 61.

Displayed on its upper surface the keyboard 22 contains a ten-key keypad 22d having 1, 2, 3, . . . and other numerals, as well as X for the multiplication operator, the adding key 22e, and the summing-up key 22f, on it.

A Hard Disk Drive (HDD) 64 is connected with the CPU 61 of the POS terminal 11. The HDD 64 has the programs and various types of files stored in it. The programs and various types of files stored in the HDD 64 are entirely or partially copied to the RAM 63 when the POS terminal 11 is started, and are then sequentially executed. An example of the program stored in the HDD 64 is the program PR for commodity sales data processing. An example of the file stored in the HDD 64 is the PLU file F1 that is sent from a store computer SC.

The PLU file F1 is a commodity file that has the information related to the sales registration of the commodity X and the image of commodity X set in it for each commodity X displayed for sale in the shop.

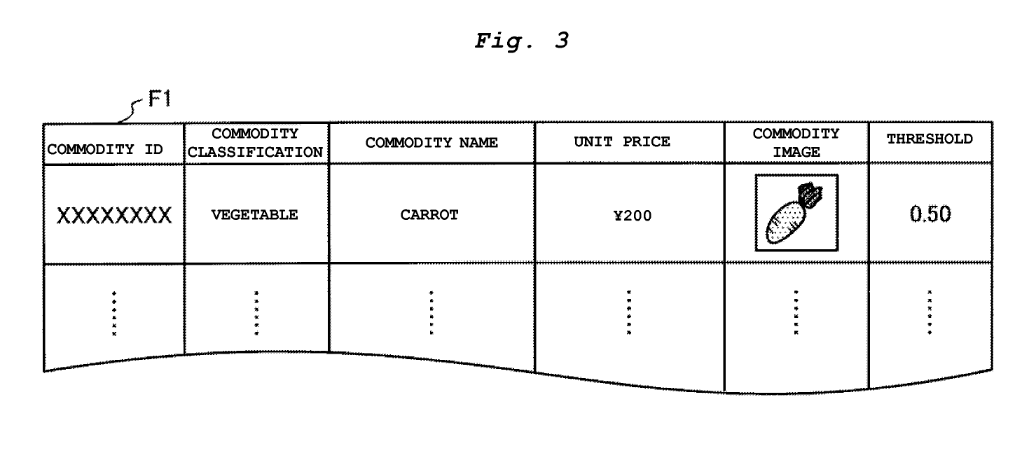

FIG. 3 is a schematic diagram illustrating an example of a structure of data of the PLU file. As shown in FIG. 3, the PLU file F1 is a file that stores, for each type of the commodity X, the commodity ID allotted uniquely to each commodity X, the commodity class, commodity name, unit price, and other information related to the commodity for each commodity X, a commodity image taken for each commodity, and a threshold of “similarity coefficient: 0.XX”, as the commodity information. The similarity coefficient is a calculated value relating to a determination of how alike the commodity is to a standard or another commodity on some possible similarity factor (size, shape, color, etc.) or multiple similarity factors. As depicted, the similarity coefficient is represented to two decimal places with two numeric values “X” (which need not both be the same number), but other representations of the similarity coefficient are contemplated including whole number representations, numbers with additional decimal places, percentages, fractions, and non-numeric representatives grading scales (e.g., scholastic grading A to F).

As to be explained later in detail, the threshold of “similarity coefficient: 0.XX” has the following function: for example, when the commodity X is fruit or other fresh product, if the commodity freshness becomes poor or the commodity becomes discolored, a comparison with the image of the commodity previously stored in the PLU file F1 enables decisions as to whether the commodity is different from its normal state. In addition, the PLU file F1 may have a constitution wherein the commodity reading device 101 can read (reference) standard images via a connection interface 65 to be explained later.

The data of the PLU file F1 is not limited to the example shown in FIG. 3. For example, characteristic quantities (such as hue, surface bump/dip state, etc.) to be explained later that can be read from the commodity image can also be correspondingly stored for each commodity.

As shown in FIG. 2, the communication interface 25 for transmitting data with the store computer SC is connected via an input/output circuit (not shown in the figure) to the CPU 61 of the POS terminal 11. The store computer SC may be set in the back (non-costumer areas), or the like, of the shop. The PLU file F1 to be sent to the POS terminal 11 is stored in the HDD (not shown in the figure) of the store computer SC. The store computer SC may also be an offsite computer located at, for example, a regional office.

In addition, the connection interface 65 that can carry out data transmission/reception with the commodity reading device 101 is connected to the CPU 61 of the POS terminal 11. The commodity reading device 101 is connected to the connection interface 65. Also, the printer 66 that prints the receipt or the like, is connected to the CPU 61 of the POS terminal 11. Under control of the CPU 61, the transaction details of each transaction are printed on a receipt.

The commodity reading device 101 also has a microcomputer 160. The microcomputer 160 includes a ROM 162 and RAM 163 connected via a bus to the CPU 161. The program executed by the CPU 161 is stored in the ROM 162. An image pickup part 164 and a sound output part 165 are connected via various types of input/output circuits (not all shown in the figure) to the CPU 161. The operations of the image pickup part 164 and the sound output part 165 are controlled by the CPU 161. The display/operating part 104 is connected via a connection interface 176 to the commodity reading part 110 and the POS terminal 11. The display/operating part 104 has its operation controlled by the CPU 161 of the commodity reading part 110 and the CPU 61 of the POS terminal 11.

The image pickup part 164 takes the pictures from the reading window 103 under control of the CPU 161. It may be a Charge Coupling Device (CCD) image sensor, a Complementary Metal-Oxide-Semiconductor (CMOS) image sensor, or the like. The image sensor may be capable of forming color images. For example, the image pickup part 164 carries out image pickup at a prescribed frame rate (such as 50 frames per second) to acquire the frame images. Then, the frame images, (picked up images) sequentially taken by the image pickup part 164 at the prescribed frame rate, are stored in the RAM 163.

The sound output part 165 is made of a voice circuit, a speaker, etc. for generating the preset alarm sound or the like. The sound output part 165 carries out notification by an alarm sound, or the like, under control of the CPU 161.

In addition, a connection interface 175 that is connected to the connection interface 65 of the POS terminal 11 and can carry out data transmission/reception with the POS terminal 11 is connected to the CPU 161. Also, the CPU 161 carries out data transmission/reception via the connection interface 175 with the display/operating part 104.

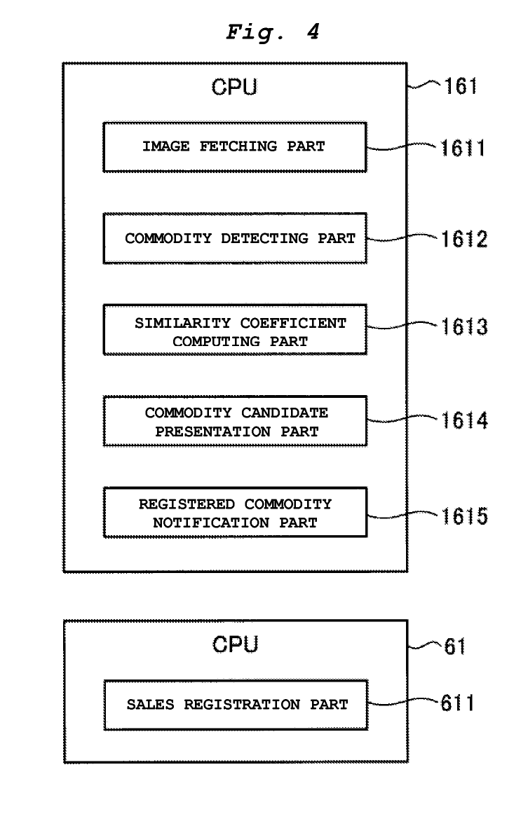

In the following, with reference to FIG. 4, the functional portions of the CPU 161 and CPU 61 that are realized as a software program are executed sequentially by the CPU 161 and CPU 61 will be explained.

FIG. 4 is a block diagram illustrating a functional constitution of the POS terminal and the commodity reading device. As shown in FIG. 4, by sequentially executing the program the CPU 161 of the commodity reading device 101 provides the functions of an image pickup part 1611, commodity detecting part 1612, similarity coefficient computing part 1613, commodity candidate presentation part 1614, and registered commodity notification part 1615. Similarly, the CPU 61 of the POS terminal 11 functions as the sales registration part 611.

The image fetching part (image pickup part) 1611 has an image pickup ON signal output to the image pickup part 164 to start the image pickup operation of the image pickup part 164. The image fetching part 1611 sequentially fetches the frame images taken by the image pickup part 164 after starting the image pickup operation. The fetching of the frame images results in the frame images being stored in the RAM 163.

The commodity detecting part 1612 uses pattern matching technology, or the like, to detect all or some portion of the commodity X contained in the frame images fetched by the image fetching part 1611. More specifically, the commodity detecting part 1612 can extract the contour line, or the like, from a binary image converted from the fetched frame image. Then, the commodity detecting part 1612 compares the contour line extracted from the previous frame image and the contour line extracted from the frame image of the current round, and it detects the portions that have changed.

As another method for detecting the commodity X, the yes/no of a skin color region on the fetched frame image is detected (that is, it is determined if flesh tone regions are in the frame imaged; if yes, then it is likely the salesperson is holding the commodity to be detected). If a skin region is detected, that is, when the image of the hand of the salesperson is detected, by carrying out detection of the contour line, efforts are made to extract the contour of the commodity assumed to be held by the hand of the salesperson. At this time, when a contour indicating the shape of the hand of the salesperson and another contour are detected, the image of the commodity is detected as the contour being held by the hand of the salesperson.

The similarity coefficient computing part 1613 reads the hue, the surface bump/dip state, and other surface states of the commodity X as characteristic quantities for the entire, or a portion of, the image of the commodity X taken by the image pickup part 164 for each of the frame images fetched by the image fetching part 1611. In order to shorten the processing time, the similarity coefficient computing part 1613 need not consider the contour and size of the commodity X, but could rely only on hue, surface texture, or other details.

Also, the similarity coefficient computing part 1613 reads the hue, the surface bump/dip state, and other surface state of the registered commodity from the commodity image (the standard image) of each commodity registered in the PLU file F1 (registered commodity) as the characteristic quantities, and compares them with the characteristic quantities of the commodity X contained in the frame images taken by the image pickup part 164, and then computes the similarity coefficient between the commodity X contained in the frame image taken by the image pickup part 164 and the commodity image registered in the PLU file F1. Here, the similarity coefficient indicates the degree of how the image, in its entirety or a portion of the commodity X, is similar to the standard image of the registered commodities stored in PLU file F1 A perfect match to standard image is taken to have a similarity coefficient of 100%=“similarity coefficient: 1.0”. As explained above, for example, the similarity coefficient is computed corresponding to the hue, the surface bump/dip state, and other surface states. Also, for example, for the hue, the surface bump/dip state, etc., the weighting factors may be adjusted, such that, for example, hue is given relatively more importance in determining the similarity score than surface texture (bump/dip state).

In addition, the similarity coefficient computing part 1613 judges whether the similarity coefficient computed for each registered commodity is over a preset threshold of “similarity coefficient: 0.XX” for the registered commodity, and recognizes (determines) the registered commodity with a similarity coefficient over the threshold as a candidate commodity X (commodity candidate). When the characteristic quantities of the various commodity images are stored corresponding to the commodities in the PLU file F1, one may also adopt a scheme in which a comparison is carried out using the characteristic quantities already stored in the PLU file F1 rather than re-evaluating characteristic quantities for the standard images each time.

Recognition of the object contained in the image is called generic object recognition. For generic object recognition, various types of recognition technologies have been described in the following reference, which is incorporated herein by reference: K. Yanagi, “Review and prospects of generic object recognition,” Joho Shori Gakkai Ronbunshi [Journal of Information Processing Society of Japan], Vol. 48, No. SIG16 (November 2007).

There is no specific restriction on the method for computing the similarity coefficient between the image of commodity X contained in the acquired frame image and the standard image of the registered commodity registered in the PLU file F1. For example, the similarity coefficient between the image of commodity X contained in the acquired frame image and the standard image may be computed as an absolute evaluation or a relative evaluation.

When the former method is adopted, the acquired image of the commodity X and the standard image of each registered commodity are compared with each other, and the similarity coefficient between them determined as a result of such a comparison is adopted. On the other hand, when the latter method is adopted, for example, suppose there are 5 registered commodities (commodities XA, XB, XC, XD, XE) registered in the PLU file F1, the similarity coefficient for commodity X compared to commodity XA is 0.6, for commodity XB is 0.1, for commodity XC is 0.1, for commodity XD is 0.1, and for commodity XE is 0.1, so that the total sum of the similarity coefficient of the various registered commodities is computed to be 1.0 (100%).

However, consider that because the frame images used to determine the similarity coefficients can be acquired under different image pickup conditions, such as different picture angles, different lighting, etc., different commodity candidates may be recognized for the different frame images because of these differences in imaging conditions. To account for this possibility, the commodity candidate presentation part 1614, on the basis of the similarity coefficient between the image of the commodity X (object) contained in the frame image last fetched by the image fetching part 1611, and the preceding frame image and the commodity image of the registered commodity, the commodity image (commodity information) of the registered commodity with a high similarity coefficient is read from the PLU file F1, and a prescribed number of images are sequentially displayed on the display device 106 in descending order of the similarity coefficient computed by the similarity coefficient computing part 1613. Details of the treatment related to the display of the commodity image will be explained later.

For the commodity candidate presentation part 1614, as the selection of one commodity image from the commodity images displayed on the display device 106 is received via the touch panel 105, the registered commodity of the selected commodity image is judged to correspond to the commodity X. Then, the commodity candidate presentation part 1614 outputs the information indicating the registered commodity (such as the commodity ID and commodity name, the image file name of the selected commodity image, etc.) to the registered commodity notification part 1615.

According to the present embodiment, the commodity candidate presentation part 1614 has the commodity image displayed on the display device 106. However, one may also adopt a scheme in which other commodity information may be displayed in addition to the image, such as the commodity name, commodity price, or other text information. Or it is also possible that just text information alone could be displayed; or both the text information and the commodity image may be displayed.

The registered commodity notification part 1615 notifies the POS terminal 11 with the commodity ID corresponding to the registered commodity as instructed by the commodity candidate presentation part 1614, together with the sales quantity input separately via the touch panel 105 or the keyboard 107. The notification of the commodity ID may be a direct notification of the commodity ID read by the registered commodity notification part 1615 from the PLU file F1, or it may be a notification of the image file name and the commodity name that allows identification of the commodity ID. It may also be a notification to the POS terminal 11 about the storage location of the commodity ID (the storage address in the PLU file F1).

On the basis of the commodity ID and the sales quantity notified by the registered commodity notification part 1615, the sales registration part 611 registers the sale of the corresponding commodity. More specifically, with reference to the PLU file F1, the sales registration part 611 registers the sale for the commodity ID and the commodity class, commodity name, unit price, etc. together with the sales quantity corresponding to the commodity ID.

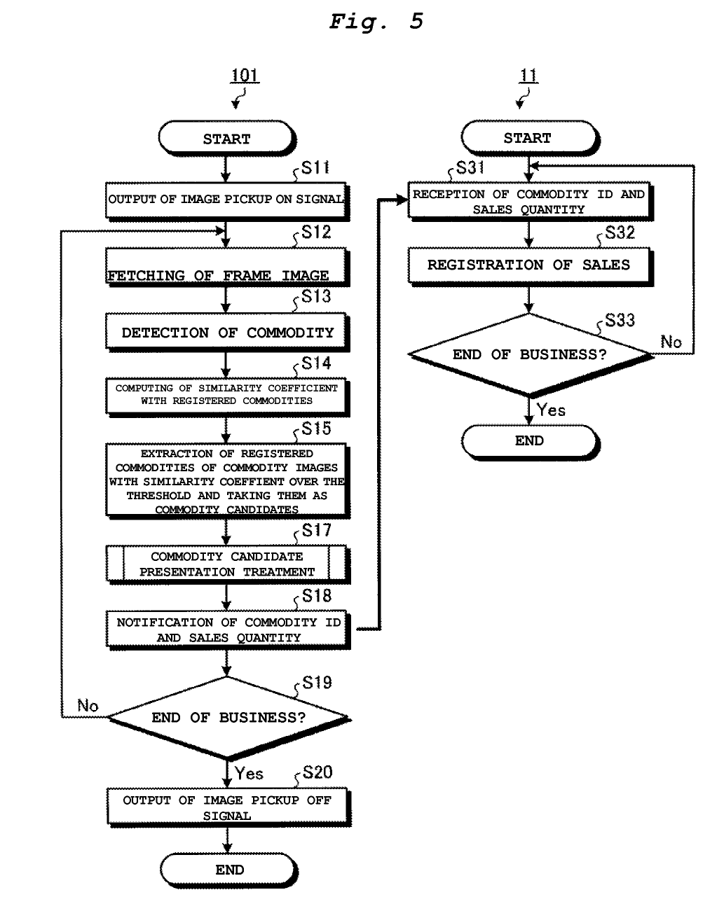

In the following, the operation of the checkout system 1 will be explained in detail. FIG. 5 is a flow chart illustrating an example of an operation of the checkout system according to the present embodiment.

First, the operation of the commodity reading device 101 will be explained. As shown in FIG. 5, as processing starts with the start of the first commodity registration by the POS terminal 11, the image fetching part 1611 outputs an image pickup ON signal to the image pickup part 164, and starts the image pickup (step S11).

The image fetching part 1611 fetches the frame image (picked up image) taken by the image pickup part 164 and stored in the RAM 163 (step S12). Then, the commodity detecting part 1612 detects the entire commodity X or a portion of it from the frame image fetched by the image fetching part 1611 (step S13). Then, the similarity coefficient computing part 1613 reads the characteristic quantities of the commodity X from either the entire, or a portion of the, detected commodity X, and it compares these characteristic quantities with the characteristic quantities of the commodity images of the various commodities registered in the PLU file F1 (step S14).

Then, the similarity coefficient computing part 1613 judges whether the similarity coefficient computed for each registered commodity is over the preset threshold for the registered commodity (“similarity coefficient threshold: 0.XX”), and it extracts the registered commodity with the similarity coefficient over the threshold as a commodity candidate for the commodity X (step S15).

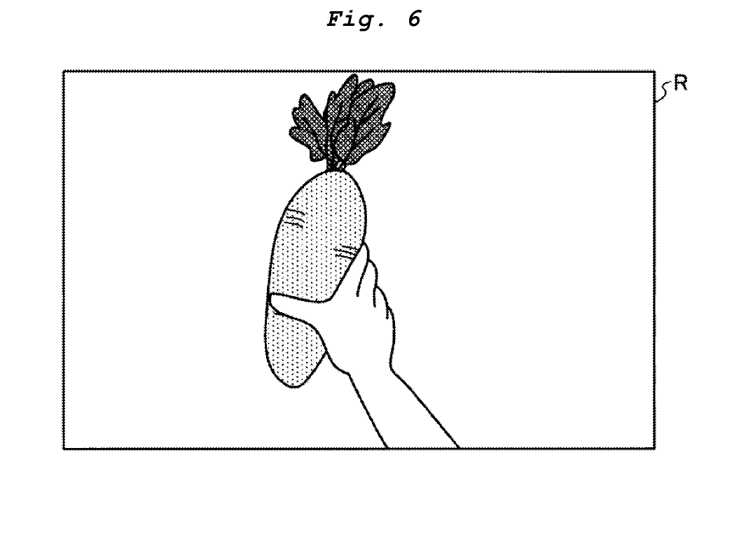

FIG. 6 is a schematic diagram illustrating an example of the reading region on the reading window. More specifically, FIG. 6 is a schematic diagram illustrating an example of the reading region R when the commodity X is read. As shown in FIG. 6, when the commodity X enters the reading region R, for example, during the process of moving commodity X from shopping basket 153a to shopping basket 153b, the frame image is obtained by taking pictures of the reading region R, then the entirety of commodity X, or a portion thereof, is detected from the frame image. As the entire commodity X, or a portion of it, is detected, recognition of the commodity X is carried out in step S14.

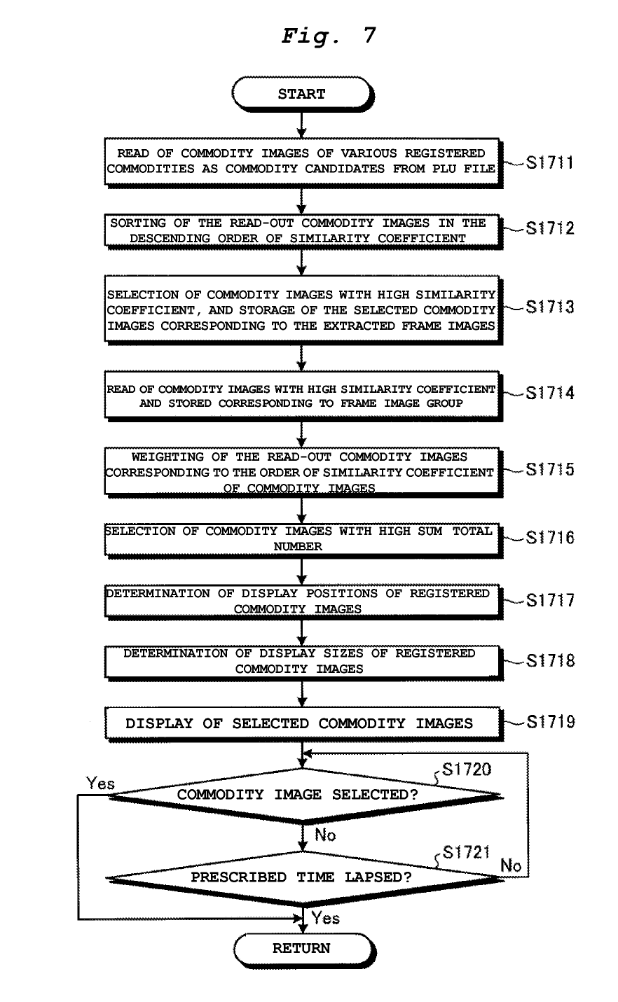

When the commodity candidates for the commodity X are extracted, the commodity candidate presentation part 1614 moves to step S17 of the operation of the commodity candidate presentation treatment. In the following, with reference to FIG. 7, the operation of the commodity candidate presentation treatment in step S17 will be explained.

FIG. 7 is a flow chart illustrating an example of the operation of the commodity candidate presentation treatment. First, the commodity candidate presentation part 1614 reads the commodity image of each registered commodity as the commodity candidate from the PLU file F1 (step S1711). Then, the commodity candidate presentation part 1614 sorts the read-out commodity images in descending order of the similarity coefficient computed in step S14 (step S1712). Then, from the read-out commodity images, the commodity candidate presentation part 1614 selects the predetermined number of the commodity images in descending order of the similarity coefficient. Next, the commodity candidate presentation part 1614 has the selected commodity image corresponding to the frame image extracted as a commodity candidate, and has it stored in the RAM 163 of the commodity reading device 101 or the like (step S1713).

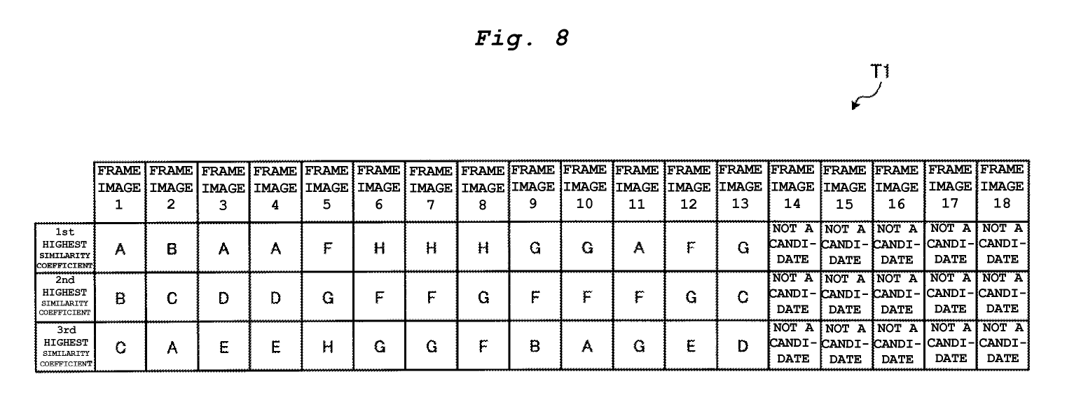

FIG. 8 is a diagram illustrating an example of a commodity image table that stores the commodity images corresponding to the frame images. As shown in FIG. 8, the commodity image table T1 has the standard commodity images with the best three similarity coefficients among the various standard commodity images of the registered commodities as the commodity candidates corresponding to the frame images from which the commodity image was extracted, and stores them in the fetching order of the frame images (i.e., the order in which the corresponding frame images were initially obtained).

Then, from the commodity image table T1, the commodity candidate presentation part 1614 reads the commodity images with high similarity coefficients (such as the commodity images with the three highest similarity coefficients), the commodity candidate being stored corresponding to the frame image last fetched by the image fetching part 1611 as well as its preceding frame image, within a prescribed frame number (prescribed time) (hereinafter to be referred to as an image group) (step S1714).

Then, the commodity candidate presentation part 1614 applies weighting factors to the commodity images read in step S1714, the weighting factors corresponding to the order of the similarity coefficient of the commodity images (step S1715). According to the present embodiment, the commodity candidate presentation part 1614 gives a point number in an ascending order corresponding to the ascending order of the similarity coefficients for the stored commodity images corresponding to the various frame images contained in the image group. Then, the commodity candidate presentation part 1614 adds up the point numbers given to the stored commodity images to compute a sum point number (a total) for the commodity images for each commodity. As a result, the commodity candidate presentation part 1614 carries out weighting for the commodity image read in step S1714. Then, the commodity candidate presentation part 1614 computes the sum point number for the commodity images for each commodity stored in the RAM 163 of the commodity reading device 101.

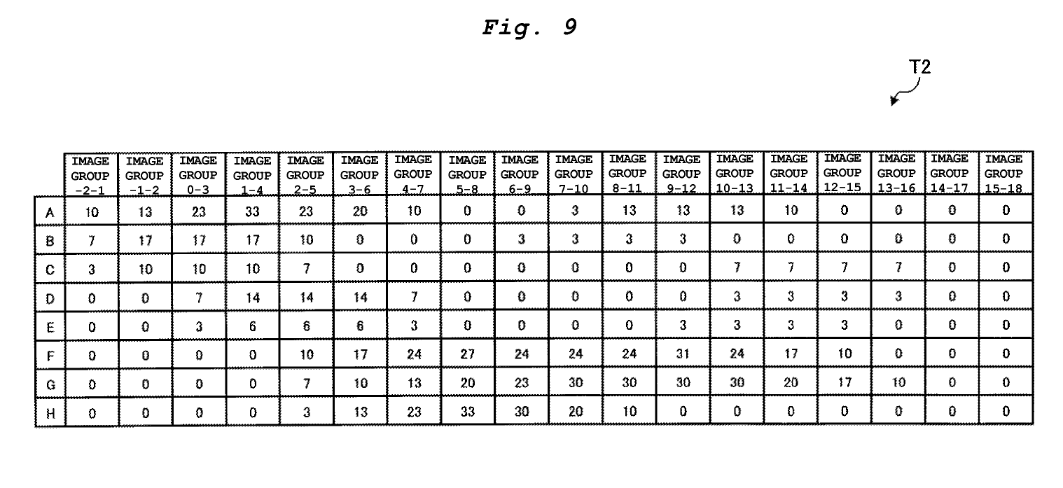

FIG. 9 is a diagram illustrating an example of the commodity image weight table having the sum point number of each commodity image stored in each image group. A commodity image weight table T2 stores the sum point number for each computed commodity image. As an example, when the frame image last fetched is a frame image 4, the commodity candidate presentation part 1614 reads from the commodity image table T1 the commodity images A-H with the three highest similarity coefficients stored corresponding to the frame image 4 and frame images 1-3 fetched after fetching the frame image 4 and within a prescribed frame number (3 frames). Then, with the commodity candidate presentation part 1614, among the commodity images A, D, and E with the three highest similarity coefficients stored corresponding to the frame image 4, for commodity image A with the highest similarity coefficient, 10 points are applied, for commodity image D with the second highest similarity coefficient, 7 points are applied, and, for commodity image E with the third highest similarity coefficient, 3 points are applied. For commodity images A-E stored corresponding to frame images 1-3, the commodity candidate presentation part 1614 applies the point number in the same way as that above. Then, commodity candidate presentation part 1614 adds up the point numbers given to commodity images A-H with the three highest similarity coefficients stored corresponding to the various frame images 1-4 (the sum point number for commodity image A: 33 points, the sum point number for commodity image B: 17 points, the sum point number for commodity image C: 10 points, the sum point number for commodity image D: 14 points, the sum point number for commodity image E: 6 points, and the sum point number of the commodity images F-H: 0 points).

Then, among the commodity images with the sum point number stored corresponding to the image group containing the frame image last fetched in the commodity image weight table T2, the commodity candidate presentation part 1614 selects a prescribed number (e.g., 3) of commodity images having the highest sum point numbers (step S1716). As a result, on the basis of the similarity coefficient between the image of the commodity X contained in the image group and the standard commodity images, the standard commodity images with high similarity coefficients are selected.

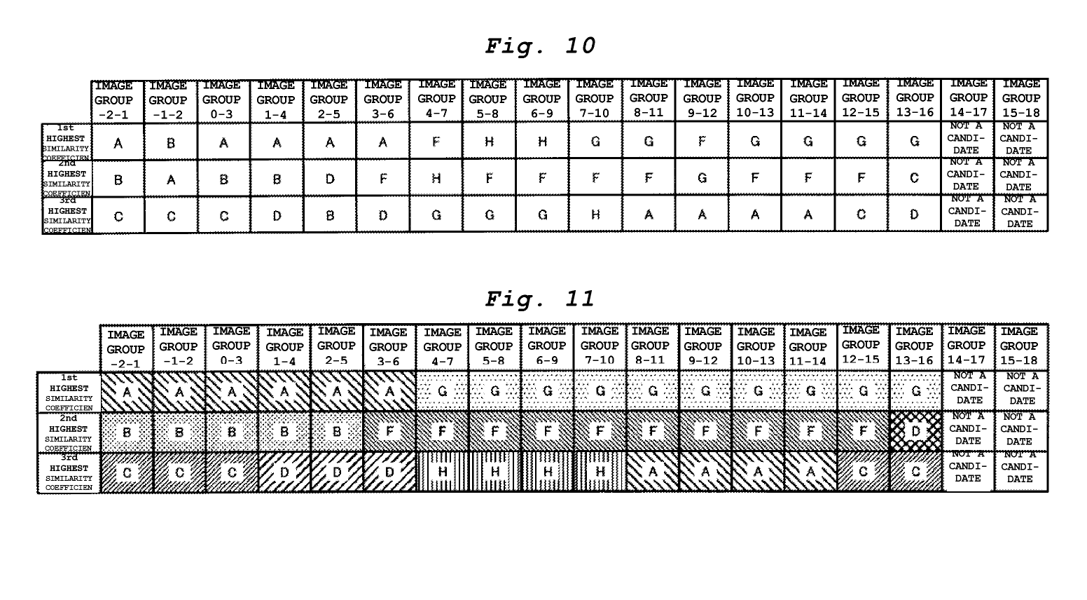

FIG. 10 is a diagram illustrating an example of selecting commodity images with high similarity coefficients. As an example, suppose the frame image last fetched is frame image 4, from the commodity image weight table T2, the commodity candidate presentation part 1614 specifies the sum point numbers of the three commodity images A, B, and D (33 points, 17 points, and 14 points), in descending order of the sum point numbers of the commodity images A-H stored corresponding to the image group 1-4 containing the frame image 4 that is the last fetched. Then, the commodity candidate presentation part 1614 selects the commodity images A, B, and D with the prescribed sum point numbers (33 points, 17 points and 14 points) as the commodity images with highest similarity coefficients.

Then, the commodity candidate presentation part 1614 determines the display position of the selected commodity images when they are displayed on the display device 106 (step S1717). More specifically, when the commodity images selected in step S1716 are the same as the commodity images selected when the frame image is fetched in the last round, the commodity candidate presentation part 1614 determines the display position of the commodity images selected in step S1716 close to the same display position as the display position of the commodity images selected when the frame image is fetched in the last round.

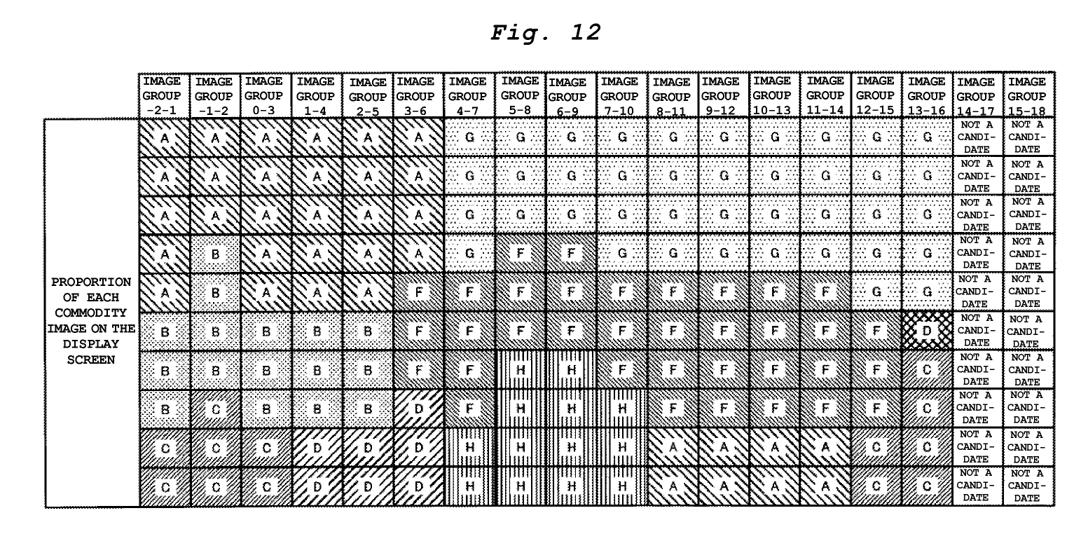

FIG. 11 is a diagram illustrating an example of a display position table that stores the results of the determined display position of the selected commodity images. A display position table T3 stores the display positions 1-3 of the commodity images selected in step S1716 corresponding to the image group. As an example, when the last fetched frame image is the frame image 4, from the display position table T3, the display positions 1 and 2 of the selected commodity images A and B, are determined by the commodity candidate presentation part 1614 and are the same as the display positions of the selected commodity images A, B, and D amongst the display positions 1-3 of the commodity images A, B, and C stored corresponding to the image group 0-3 containing frame image 3 fetched in the last round.

In addition, corresponding to the weight applied on the commodity image selected in step S1716, the commodity candidate presentation part 1614 sets the display size of the selected commodity image (step S1718). According to the present embodiment, the commodity candidate presentation part 1614 works as follows: in the commodity image weight table T2, as the sum point number stored corresponding to the commodity image selected in step S1716, becomes larger, the display size of the selected commodity image is made larger as well.

FIG. 12 is a diagram illustrating an example of results of the decision of the display size of the selected commodity image. Here, the commodity candidate presentation part 1614 determines the proportion (display size) of the selected commodity image on the display screen of the display device 106 corresponding to the weight for the commodity image selected in step S1716. As an example, first of all, the commodity candidate presentation part 1614 computes the sum (64 points) of the sum point numbers (33 points, 17 points, and 14 points) stored corresponding to the selected commodity images A, B, and D. Then, with respect to the computed sum (64 points), the commodity candidate presentation part 1614 computes the proportion (0.5, 0.3, 0.2) of the sum point numbers (33 points, 17 points, 14 points) of the commodity images A, B, and D, respectively. Next, according to the computed proportions (0.5, 0.3, 0.2) of the commodity images A, B, and D, the commodity candidate presentation part 1614 determines, on the display screen of the display device 106, the proportions (50%, 30%, 20%) occupied by the commodity images A, B, and D, respectively.

According to the present embodiment, corresponding to the weight applied on the selected commodity images, the commodity candidate presentation part 1614 changes the display size of the selected commodity images. However, the present disclosure is not limited to this scheme. Any display scheme may be adopted as long as the display state of the selected commodity images can be changed corresponding to the weight applied to the selected commodity images. For example, one may also adopt a scheme in which, corresponding to the weight applied on the selected commodity images, the commodity candidate presentation part 1614 makes the selected commodity images flash, or makes the color of the selected commodity images change.

Then, according to the display position determined in step S1717 and the display size determined in step S1718, the commodity candidate presentation part 1614 displays the commodity images with high similarity coefficients selected in step S1716 on the display device 106 (step S1719).

Then, the commodity candidate presentation part 1614 judges which of the commodity images displayed on the display device 106 was selected by means of the touch panel 105 or the keyboard 107 (step S1720). Here, when it is judged that one of the commodity images was selected (YES in step S1720), the commodity candidate presentation part 1614 judges that the registered commodity corresponding to the selected commodity image corresponds to the commodity X, and it outputs the information indicating the registered commodity to the registered commodity notification part 1615, and it then goes on to step S18 shown in FIG. 5.

On the other hand, when it is judged that no commodity image is selected (NO in step S1720), the commodity candidate presentation part 1614 immediately judges whether a prescribed time has passed from the time when display of the commodity images is carried out in the nearest step S1719 until fetching of the next frame image (step S1721). Then, if the prescribed time has not passed until fetching of the next frame image (NO in step S1721), it returns to step S1720.

In step S1721, if it is judged that a prescribed time has passed until fetching of the next frame image (YES in step S1721), the commodity candidate presentation part 1614 judges that the registered commodity corresponding to the selected commodity image does not correspond to the commodity X, and it goes to step S18 shown in FIG. 5.

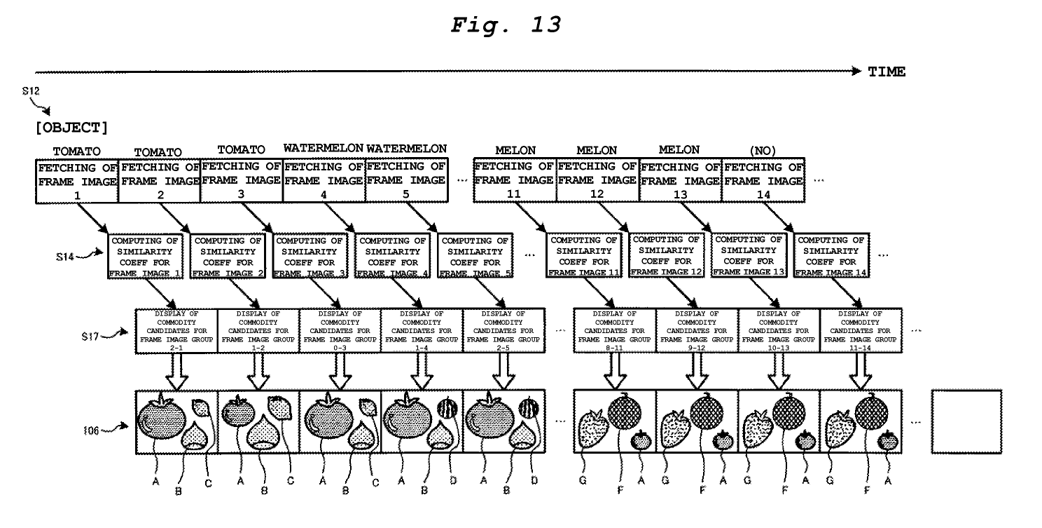

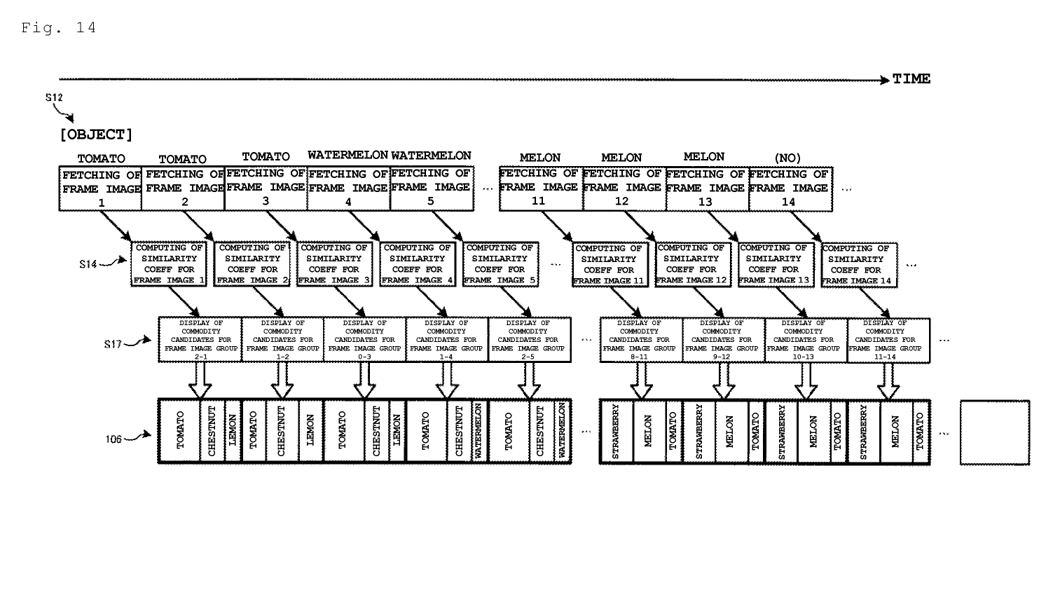

In the following, with reference to FIGS. 8 through 13, the operation of the commodity candidate presentation treatment will be explained. FIG. 13 is a diagram illustrating the commodity candidate presentation treatment.

First, an explanation will be given for the case when the commodity X as the object for image pickup by the image pickup part 164 is changed from “tomato” to “watermelon”. Initially, frame images (e.g., frame image 1-3) show a “tomato”. In step S12, the image fetching part 1611 fetches the frame image 4 taken for the commodity X: “watermelon”. Then, in step S13, as the commodity detecting part 1612 detects the entirety or a portion of the commodity X: “watermelon” from frame image 4, in step S14, the similarity coefficient computing part 1613 reads the characteristic quantities of the commodity X: “watermelon” from the entire commodity X:, or a portion thereof, contained in frame image 4 and compares them with the characteristic quantities of the commodity images of the commodities registered in the PLU file F1 to compute the similarity coefficient, and in step S15 (which may be overlap with step S14), it extracts the registered commodities corresponding to the commodity images with the computed similarity coefficient over a prescribed threshold (e.g., similarity coefficient threshold: 0.50) as the commodity candidates for the commodity X: “watermelon”.

After the commodity candidates are extracted the commodity candidate presentation part 1614 executes the commodity candidate presentation treatment in step S17. More specifically, in step S1711, the commodity candidate presentation part 1614 reads the commodity images of the registered commodities as the commodity candidates from the PLU file F1. Then, in step S1712, the commodity candidate presentation part 1614 sorts the candidate commodity images in descending order of the similarity coefficient computed in step S14, while in step S1713, commodity candidate presentation part 1614 selects the commodity images with the three highest similarity coefficients, that is, in this example: commodity image A (the image of the registered commodity: “tomato”), commodity image D (the image of the registered commodity: “watermelon”), and commodity image E (the image of the registered commodity: “banana”). The selected commodity images A, D, and E stored in the commodity image table T1 as corresponding/correlated to the frame image 4.

Then, in step S1714, the commodity candidate presentation part 1614 reads the high similarity commodity images corresponding to the frame image 4 and as well as high similarity commodity images corresponding to the frame images 1-3 fetched preceding frame image 4 (stored images within 3 frames of frame image 4 in the commodity image table T1). Here, the commodity image B is the image of the registered commodity: “chestnut”, and the commodity image C is the image of the registered commodity: “lemon”, as depicted in FIGS. 13 and 14.

Then, in step S1715, the commodity candidate presentation part 1614 carries out a weighting application/function on the commodity images stored corresponding to frame images 1-4. More specifically, the commodity candidate presentation part 1614 works, for example, as follows: among the commodity images A, D, and E stored corresponding to the frame image 4, a point total of 10 points is given to the commodity image A (the image with the highest similarity coefficient), a point total of 7 points is given to the commodity image D (the image with the second highest similarity coefficient), and a point total of 3 points is given to the commodity image E (the image with the third highest similarity coefficient).

Also, the commodity candidate presentation part 1614 works as follows: among the commodity images A, B, and C stored corresponding to the frame image 1, 10 points is given to the commodity image A with the highest similarity coefficient, 7 points is given to the commodity image B with the second highest similarity coefficient, and 3 points is given to the commodity image C with the third highest similarity coefficient.

Also, the commodity candidate presentation part 1614 works as follows: among the commodity images B, C, and A stored corresponding to the frame image 2, 10 points is given to the commodity image B with the highest similarity coefficient, 7 points is given to the commodity image C with the second highest similarity coefficient, and 3 points is given to the commodity image A with the third highest similarity coefficient.

In addition, the commodity candidate presentation part 1614 works as follows: among the commodity images A, D, and E stored corresponding to frame image 3, 10 points is given to the commodity image A with the highest similarity coefficient, 7 points is given to the commodity image D with the second highest similarity coefficient, 3 points is given to the commodity image E with the third highest similarity coefficient.

Then, the commodity candidate presentation part 1614 computes a summed point total of 33 for image A by adding the following point numbers: 10 points given to commodity image A stored corresponding to frame image 4, 10 points given to the commodity image A stored corresponding to the frame image 1, 3 points given to the commodity image A stored corresponding to the frame image 2, and 10 points given to the commodity image A stored corresponding to the frame image 3. Then, the commodity candidate presentation part 1614 takes the sum point number of 33 as a weighting factor for the commodity image A, and has it stored in the commodity image weight table T2 corresponding to image group 1-4. (See FIG. 9).

Also, the commodity candidate presentation part 1614 computes the sum point numbers for the other commodity images B, C, D, and E stored corresponding to the frame images 1-4 in the same manner of operation as used with commodity image A, and it takes the computed sum point numbers as the weighting factors for the commodity images B, C, D, and E, and has them stored in the commodity image weight table T2 corresponding to the image group 1-4.

Then, in step S1716, the commodity candidate presentation part 1614 selects the commodity images A, B, and D having the three highest similarity coefficients among the commodity images with the summed point total stored corresponding to the image group 1-4 in the commodity image weight table T2.

In step S1717, the commodity candidate presentation part 1614 determines the display position (from possible display positions of 1 (left hand side), 2 (middle), and 3 (right hand side)) for the commodity images of the current frame and compares them to stored positions determined for the nearest preceding image group. Here, the preceding image group corresponds to frames 0-3 (image group 0-3) and the commodity images are A, B, and C. The commodity presentation part 1614 determines the position of 1 (left hand side) and 2 (middle) for the commodity images A and B are the same as the display positions of the current commodity images A, and B. In addition, for the display position of the commodity image D, as the display position was not stored for to the nearest image group 0-3, the commodity candidate presentation part 1614 determines the display position of commodity image D to be other than the display position 1 (left hand side) and 2 (middle) of commodity images A and B, such as the right hand side or the like.

In step S1718, the commodity candidate presentation part 1614 determines the display size of the commodity image based on the weight assigned in step S1716. More specifically, in the commodity image weight table T2, the commodity candidate presentation part 1614 computes the sum of 64 points from the sum point numbers of 33 points, 17 points and 14 points of the commodity images A, B, and D stored corresponding to the image group 1-4 containing the frame image 4. Then, the commodity candidate presentation part 1614 computes the proportions of the sum point numbers of 33 points, 17 points and 14 points as 0.5, 0.3, 0.2 with respect to the computed sum of 64 points of the commodity images A, B, and D. Next, according to the proportions of 0.5, 0.3, 0.2 computed for the commodity images A, B, and D, the commodity candidate presentation part 1614 determines that the proportions of the commodity images A, B, and D on the display screen of the display device 106 are 50%, 30% and 20%, respectively.

In addition, as shown in FIG. 13, the commodity candidate presentation part 1614 works as follows: when commodity X: “watermelon” has its picture taken and fetched as frame image 4, the commodity image A of the registered commodity: “tomato” is displayed at the display position 1 (left hand side) with a 50% proportion of the display device 106. In addition, the commodity candidate presentation part 1614 displays the commodity image B of the registered commodity: “chestnut” at display position 2 (middle) on display device 106 with a proportion of 30% with respect to the display device 106. In addition, the commodity candidate presentation part 1614 displays the commodity image D of the registered commodity: “watermelon” at the display position 3 (right hand side), with a 20% proportion of display device 106.

In this way, when the frame image 4 taken for commodity X: “watermelon” is fetched, the commodity candidate presentation part 1614 works as follows: on the basis of the similarity coefficients between the images of the commodities X: “tomato” and “watermelon” contained in the frame image 4, and the frame images 1-3 fetched before the frame image 4 and the commodity images A-E of the registered commodities, it displays the commodity images A, B, and D (the images with a high similarity coefficient) on display device 106. As a result, when the commodity X taken by the image pickup part 164 is changed from “tomato” to “watermelon”, and the new frame image 4 is fetched, the commodity images A and B originally displayed on the display device 106 are not immediately deleted, instead, they continue to be displayed for a certain period of time. Consequently, it is possible to prevent switching of the commodity images while the user selects the desired commodity image from the commodity images displayed on the display device 106.

In the following, the commodity candidate presentation treatment for when there is no object to be imaged by the by the image pickup part 164 will be explained. In step S12, the image fetching part 1611 fetches the frame image 14 without the commodity X picked up. Then, in step S13, the commodity detecting part 1612 tries to detect the entire commodity X, or a portion of it, from the frame image 14 fetched by the image fetching part 1611. Here, when neither the entire commodity X, nor a portion of it, is detected from the fetched frame image 14, the similarity coefficient computing part 1613 does not carry out computing of the similarity coefficient in step S14 or extraction of the commodity candidates in step S15.

But even when the commodity candidate extraction is not carried out, the commodity candidate presentation part 1614 still executes the commodity candidate presentation treatment in step S17. More specifically, in step S1714, the commodity candidate presentation part 1614 reads commodity images A, C, D, E, F, and G, stored corresponding to the frame images 11-13, are fetched from commodity image table T1, and include the 3 frames preceding frame image 14. Here, the commodity image F is the image of the registered commodity: “watermelon”, and the commodity image G is the image of the registered commodity: “strawberry”.

In step S1715, the commodity candidate presentation part 1614 carries out a weighted application on the commodity images stored corresponding to the frame images 11-13. More specifically, the commodity candidate presentation part 1614 gives weights to the commodity images A, F, and G stored corresponding to the frame image 11 as follows: 10 points for the commodity image A with the highest similarity coefficient, 7 points for the commodity image F with the second highest similarity coefficient, and 3 points for the commodity image G with the third highest similarity coefficient.

In addition, the commodity candidate presentation part 1614 gives weights to the commodity images E-G stored corresponding to the frame image 12 as follows: 10 points for the commodity image F with the highest similarity coefficient, 7 points for commodity image G with the second highest similarity coefficient, and 3 points for commodity image H with the third highest similarity coefficient.

In addition, the commodity candidate presentation part 1614 gives weights (weighting factors) to the commodity images C, D, and G stored corresponding to the frame image 13 as follows: 10 points for the commodity image G with the highest similarity coefficient, 7 points for the commodity image C with the second highest similarity coefficient, and 3 points for the commodity image D with the third highest similarity coefficient.

For the commodity image A stored corresponding to the frame image 11, the commodity candidate presentation part 1614 computes the sum point number of the commodity image A as 10 points. Then, the commodity candidate presentation part 1614 has the sum point number of 10 points stored as the weight of the commodity image A corresponding to the image group 11-14 in the commodity image weight table T2. Then, in the same way as above, for the other commodity images C-E stored corresponding to frame images 11-13, too, the commodity candidate presentation part 1614 computes the sum point number, and has the computed sum point number stored corresponding to the commodity images C-E in the commodity image weight table T2.

The commodity candidate presentation part 1614 computes the sum point number of 17 points by adding the point number of 7 points for the commodity image F stored corresponding to the frame image 11, and the point number of 10 points for the commodity image F stored corresponding to the frame image 12. Then, the commodity candidate presentation part 1614 takes the sum point number of 17 points as the weight of the commodity image F and stores it in the commodity image weight table T2 corresponding to the image group 11-14.

Just as for the commodity image A, for another commodity image G stored corresponding to the frame images 11-13, too, the commodity candidate presentation part 1614 also computes the sum point number, and it takes the computed sum point number as the weight for the commodity image G and stores it in commodity image weight table T2 corresponding to the image group 11-14.

Then, in step S1716, among the commodity images having the sum point number stored in the commodity image weight table T2 corresponding to the image group 11-14, the commodity candidate presentation part 1614 selects the commodity images A, F, and G having the three highest sum point numbers.

In addition, in step S1717, from the display position table T3, the commodity candidate presentation part 1614 determines the display positions of the selected commodity images G, F, and A as follows: from the display positions 1 (left hand side), 2 (middle), and 3 (right hand side) of the commodity images G, F, and A stored corresponding to the nearest image group 10-13 containing the frame image 3 fetched in the last round; it selects the display positions 1 (left hand side), 2 (middle), and 3 (right hand side) of the commodity images G, F, and A same as the selected commodity images G, F, and A as the display positions of the selected commodity images G, F, and A.

In addition, in step S1718, the commodity candidate presentation part 1614 determines the display sizes of the selected commodity images corresponding to the weights for the commodity images selected in step S1716. More specifically, in the commodity image weight table T2, the commodity candidate presentation part 1614 computes the sum of 47 points of the sum point numbers of 10 points, 17 points and 20 points of the commodity images A, F, and G stored corresponding to the image group 11-14 containing the frame image 14 that is last fetched. Then, with respect to the computed sum of 47 points of the commodity images A, F, and G, the commodity candidate presentation part 1614 computes the proportions of the sum point numbers of 10 points, 17 points and 20 points of the commodity images A, F, and G as 0.2, 0.4 and 0.4, respectively. From these computed portions, for the commodity images A, F, and G, the commodity candidate presentation part 1614 determines the proportions of the commodity images A, F, and G as 20%, 40% and 40%, respectively, on the display screen of the display device 106.

As shown in FIG. 13, when the frame image 14 without a pickup of the image of the commodity X is fetched, the commodity candidate presentation part 1614 displays the commodity image G of the registered commodity: “strawberry” at the display position 1 (left hand side) on the display device 106 with a proportion of 40% of the display device 106. In addition, the commodity candidate presentation part 1614 displays the commodity image F of registered commodity: “watermelon” at the display position 2 (middle) on the display device 106 with a proportion of 40% with respect to the display device 106. In addition, the commodity candidate presentation part 1614 displays the commodity image A of the registered commodity: “tomato” at the display position 3 (right hand side) on the display device 106 with a proportion of 20% with respect to the display device 106.

In this way, when the frame image 14 without image pickup of the commodity X is fetched, the commodity candidate presentation part 1614 displays on the display device 106 the commodity images A, F, and G with high similarity coefficients on the basis of the similarity coefficients between the images of the commodities X: “tomato”, “watermelon”, “strawberry” contained in the frame images 11-13 fetched preceding the frame image 14 and the registered commodity images A, C, D, E, F, and G. As a result, when a new frame image 14 containing commodity X (or an empty frame) is fetched, the commodity images A, F, and G as the last images displayed on the display device 106 are not deleted. Instead, they continue being displayed for a prescribed period of time, so that even when the user delays in selecting the desired commodity image from the commodity images displayed on the display device 106 after the image of commodity X is picked up by the image pickup part 164, it is still possible to select the commodity image.

Now, refer to FIG. 5. Here, the registered commodity notification part 1615 notifies the POS terminal 11 of the commodity ID corresponding to the registered commodity indicated by the commodity candidate presentation part 1614 together with the sales quantity input separately via the touch panel 105 or the keyboard 107 (step S18). Here, input of the sales quantity is carried out via the touch panel 105 and the display/operating part 104. However, there is no specific restriction on the input method. For example, one may also adopt a scheme in which the number of screen touches for the commodity image displayed on the display device 106 is taken as the sales quantity.

Then, the CPU 161 judges yes/no as to the end of business (the current customer transaction) according to the notification of the end of commodity registration, or the like, from the POS terminal 11 (step S19). As business continues (NO in step S19), the CPU 161 returns to the treatment in step S12 and the treatment continues. On the other hand, when business ends (YES in step S19), the image fetching part 1611 outputs an image pickup OFF signal to the image pickup part 164, and the image pickup operation by the image pickup part 164 comes to an end (step S20), and the treatment ends.

In the following, the operation of the POS terminal 11 will be explained. As the treatment starts upon the commodity registration, etc., under instruction of operation of the keyboard 22, the CPU 61 receives the commodity ID and sales quantity of the commodity X from commodity reading device 101 (step S31).

Then, on the basis of the commodity ID and the sales quantity received in step S31, the sales registration part 611 reads from the PLU file F1 the commodity type, the unit price, etc., and it carries out registration of the sale of the commodity X read by the commodity reading device 101 (step S32).

Next, the CPU 61 judges yes/no as to the end of business according to the end of the sales registration by the operation instruction via the keyboard 22 (step S33). When business continues (NO in step S33), the CPU 61 returns to step S31 and continues the business transaction. On the other hand, when the business ends (YES in step S33), the CPU 61 ends the treatment.

According to the present embodiment, the commodity candidate presentation part 1614 changes the display sizes of the selected commodity candidates (commodity images) to correspond to weighting factors calculated based on similarity coefficients and presence in preceding image frames for the selected commodity candidates (commodity images). However, one may also adopt a scheme in which the weighting factors are applied to the commodity information (such as the commodity name, etc.) of the selected commodity candidates, such that the display sizes of the commodity information of the selected commodity candidates are changed according to the various weights.

FIG. 14 is a diagram illustrating an example of the display of the commodity name as the commodity information in the commodity candidate presentation treatment. As an example, the following case will be explained: on the basis of the similarity coefficient between the images of the commodities X contained in image group 1-4 and the commodity images of the registered commodities, the commodity information of the commodities X corresponding to the commodity images A, B, and D with high similarity coefficients is displayed. Suppose the proportions of each commodity image on the display screen is computed for the commodity images A, B, and D as 0.5, 0.3, 0.2 (see FIG. 12), as shown in FIG. 14, the commodity candidate presentation part 1614 displays the commodity name: “tomato” corresponding to the commodity image A, on 50% of the display device 106, it displays the commodity name: “chestnut” corresponding to the commodity image B on 30% the display device 106, and it displays the commodity name: “lemon” corresponding to commodity image D on 20% the display device 106.

One may also adopt a scheme in which together with the commodity images of the commodity candidates or the commodity names of the commodity candidates displayed by the commodity candidate presentation part 1614, the real-time picked up image displaying the frame image last picked up by the image pickup part 164, is displayed on the same screen of the display device 106. That is, the current, real-time frame image from image pickup part 164 is displayed with the candidate commodity images on the display unit.

As explained above, for the checkout system 1 in this embodiment, each time a frame image is fetched, the similarity coefficient between the images of commodities X contained in the latest fetched frame image and the registered commodity images (the standard images) is determined. The similarity coefficient between commodities in the previous image frames and the standard images have also been previously calculated and stored. On the basis of these similarity coefficients, the commodity images with high similarity coefficients are displayed on the display device 106. Since similarity results from previous frames can be included in setting the display the commodity images displayed on the display device 106 are not immediately deleted each time when a new frame image is fetched. Instead, previous candidate commodity images can continue to be displayed for a certain period of time. Consequently, when the user selects the desired commodity image from the commodity images displayed on the display device 106, it is possible to prevent a hasty switch of the displayed commodity images as the commodities being imaged by image pickup part 164 changes.

In addition, according to the checkout system 1 in this embodiment, when the commodity image of the registered commodity with a high similarity coefficient is identical to the commodity image of the registered commodity displayed when the frame image is fetched in the last round, the commodity image of the registered commodity with a high similarity coefficient is displayed at almost the same display position as that of the commodity image of the registered commodity displayed when the frame image is fetched in the last round. Consequently, when the same commodity X has the image picked up consecutively, there is no change in the position of the commodity image displayed as a commodity candidate of the commodity X. As a result, it is possible to improve the operability of the user when selecting the desired commodity image from the displayed commodity images, since candidate commodity images will not move/jump around the screen as the user makes a selection.

While certain embodiments have been described, these embodiments have been presented by way of example only, and are not intended to limit the scope of the invention. Indeed, the novel embodiment described herein may be embodied in a variety of other forms; furthermore, various omissions, substitutions and changes in the form of the embodiment described herein may be made without departing from the spirit of the invention. The accompanying acclaims and their equivalents are intended to cover such forms or modifications as would fall within the scope and spirit of the invention.

In the example embodiment, the registered commodity image with high similarity coefficient is displayed as the commodity information of the commodity X on the basis of the similarity coefficient between the commodity image of the registered commodity and the images of the commodity X contained in the last fetched frame image as well as the frame images fetched within three preceding frames. However, the present disclosure is not limited to the scheme. Any scheme may be adopted as long as the commodity images with high similarity coefficients are displayed as the commodity information of the commodity X on the basis of the similarity coefficient between the commodity image of the registered commodity and the images of the commodity X contained in the last fetched frame image and the frame image fetched a plurality of frames preceding the last fetched frame image.

In the embodiment, the POS terminal 11 is assumed to have the PLU file F1. However, the present disclosure is not limited to the scheme. One may also adopt a scheme in which the commodity reading device 101 has the PLU file F1 or an external device that can be accessed by the POS terminal 11 and the commodity reading device 101 has the PLU file F1.

In the embodiment, the POS terminal 11 and the commodity reading device 101 are arranged as two units. However, the present disclosure is not limited to the scheme. One may also adopt a scheme in which the POS terminal 11 and the commodity reading device 101 are set together as a single unit with both functions. The POS terminal 11 may also be arranged such that someone other than the salesperson handles or may handle commodities X during image capturing processing by reading device 101. Such other person may be a customer or an assistant to the salesperson.

In the embodiment, the programs executed by the various devices are preset in the storage media (ROM or storage part) equipped in the various devices and are then provided. However, the present disclosure is not limited to the scheme. One may also adopt a scheme in which the files, in installable format or executable format, are stored in recording media, such as CD-ROM, floppy disk (FD), CD-R, Digital Versatile Disk (DVD), etc., that can be read by the computer. In addition, the recording media are not limited to the media independent from the computer or the assembly system. That is, the programs may also be stored or temporarily stored in LAN, internet, or other downloadable storage media locations.

In addition, for the programs executed in the various devices in the embodiment, one may also adopt a scheme in which the programs are stored in a computer connected with internet or another network so that programs and data can be distributed by downloading via the internet or other network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A checkout system, comprising:
a terminal to register sales of a commodity; and
a commodity reading device including an image pickup part to acquire an image of the commodity; and
a display device;
wherein,
the commodity reading device detects the commodity from the acquired image, and computes a similarity coefficient between the detected commodity image and a standard image for each commodity from a list of commodities to determine candidate matches for the commodity from the acquired image and display the candidate matches on the display device.

2. The checkout system of claim 1, wherein
the commodity reading device displays a predetermined number of candidate matches on the display device based on the confidence of the similarity coefficient.

3. The checkout system of claim 2, wherein
the display of the predetermined number of candidate matches is controlled such that a candidate match with a higher similarity coefficient is displayed at a larger size than a candidate with a lower similarity coefficient.

4. The checkout system of claim 3, wherein
the standard image for the candidate matches is displayed on the display device.

5. The checkout system of claim 3, further comprising:
a checkout table;
a drawer disposed on the checkout table, the drawer connected to the sales terminal; and
a counter table, the commodity reading device disposed on the counter table.

6. The checkout system of claim 5, wherein
the sales terminal comprises a customer display device, a keyboard, and an operator display device with a touch screen for an operator to register sales; and
the commodity reading device further includes a touch panel and a keyboard for a user to select the candidate match corresponding to the commodity in the acquired image.

7. A method for operating a checkout system, comprising:
acquiring an image of a commodity;
detecting a commodity type of the acquired image of the commodity from a list of commodities;
calculating a similarity coefficient between the detected commodity type and each commodity on the list of commodities;
extracting candidate matches for the detected commodity type from the list of commodities based on the similarity coefficient;
displaying a predetermined number of candidate matches on a display unit;
receiving a user selection from the displayed candidates matches; and
transmitting the user selection to a sales terminal.

8. The method of claim 7, further comprising:
registering a sale at the sales terminal corresponding to the user selection.

9. The method of claim 7, wherein the image of the commodity is acquired with an image pickup part disposed on a counter table.

10. The method of claim 7, wherein the commodity in the acquired image is recognized based on a detection of flesh color in the acquired image.

11. The method of claim 7, wherein the list of commodities is a PLU list.

12. The method of claim 7, wherein the display of the predetermined number of candidate matches includes the display of a standard image for each candidate match.

13. The method of claim 12, wherein a size of the standard image for each candidate match is varied based on the relative value of the similarity coefficients for each candidate match.

14. A non-transitory computer readable medium storing a computer program which when executed causes a computer to perform steps comprising:
acquiring an image of a commodity;
detecting a commodity type of the acquired image of the commodity from a list of commodities;
calculating a similarity coefficient between the detected commodity type and each commodity on the list of commodities;
extracting candidate matches for the detected commodity type from the list of commodities based on the similarity coefficient;
displaying a predetermined number of candidate matches on a display unit;
receiving a user selection from the displayed candidates matches; and
transmitting the user selection to a sales terminal.

15. The medium of claim 14, wherein the steps performed further comprises:
accessing a file containing a PLU list to establish the list of commodities.

16. The medium of claim 14, wherein the steps performed further comprises:
registering a sale at the sales terminal corresponding to the user selection.

17. The medium of claim 14, wherein the displaying of the predetermined number of candidate matches includes displaying a standard image for each candidate match.

18. The medium of claim 17, wherein the displaying of each candidate match comprising changing a size of the standard image display based on the relative values of the similarity coefficient of each candidate match.

19. The medium of claim 14, wherein the steps performed further comprises:
storing the calculated similarity coefficient for each candidate match.

20. The medium of claim 19, wherein the displaying of the predetermined number of candidate matches includes determining a display position on the display unit based on similarity coefficients calculated for the commodity in one or more image frames.
